(19) United States
(12) Patent Application Publication
(10) Pub. No.: US 2015/0120424 A1
(43) Pub. Date: Apr. 30, 2015

(54) MOBILE POINT SAVING SYSTEM AND METHOD

(71) Applicant: WEAVERS MIND INC., Seoul (KR)

(72) Inventor: Sung Jun PARK, Seoul (KR)

(73) Assignee: WEAVERS MIND INC., Seoul (KR)

(21) Appl. No.: 14/079,151

(22) Filed: Nov. 13, 2013

(30) Foreign Application Priority Data
Oct. 31, 2013 (KR) 10-2013-0131497

(51) Int. Cl. G06Q 30/02

(52) U.S. Cl. CPC G06Q 30/0226
USPC 705/14.27

(57) ABSTRACT

Provided is a mobile point saving system. The mobile point saving system includes an affiliate-side payment acquisition part, a user-side payment acquisition part, a payment content matching part, and a point saving part. The affiliate-side payment acquisition part receives affiliate payment information from an affiliate terminal and stores the affiliate payment information by each item when a payment event occurs. The user-side payment acquisition part receives user payment information from a user terminal to store the user payment information by each item. The payment content matching part matches contents of the affiliate payment information and the user payment information by each item to determine whether or not the affiliate payment information and the user payment information occur from the same payment event. The point saving part saves points in a user account corresponding to the user payment information.

### RELATED APPLICATIONS

This application claims the benefit of Korean Patent Application No. 10-2013-0131497, filed on Oct. 31, 2013, in the Korean Intellectual Property Office, the disclosure of which is incorporated herein in its entirety by reference.

### BACKGROUND

1. Field

One or more embodiments of the present invention relate to a mobile point saving system and method, and more particularly, to a mobile point saving system and method, which saves points in a user account by confirming payment information generated from the same payment event through matching between affiliate-side payment information and user-side payment information.

2. Description of the Related Art

Recently, as mobile terminals (e.g., smart-phones, tablet PCs, PDAs, etc.), particularly, mobile terminals with higher specifications are increasingly used, it is generalized to download various applications for these mobile terminals. Among those applications, it has been also developed what makes it available to access to text messages received by mobile terminals and then to extract contents from the text messages.

On the other hand, shops engaged to provide customers with services are offering various advantages in order to increase their royalty to customers in double. As a sort of method providing advantages to customers, there is a point provision service system in which points are given to customers according to the payment amount, and in future, customers use the points like cash when they use services.

### SUMMARY

One or more embodiments of the present invention include a mobile point saving system and method, which enables point saving without carrying a physical point saving tool by automatically acquiring a payment confirmation text from a user terminal to save points.

One or more embodiments of the present invention include a mobile point saving system and method, which saves points in an appropriate user account by saving points through matching between affiliate-side payment information and user-side payment information.

Additional aspects will be set forth in part in the description which follows and, in part, will be apparent from the description, or may be learned by practice of the presented embodiments.

According to one or more embodiments of the present invention, a mobile point saving system includes: an affiliate-side payment acquisition part receiving affiliate payment information from an affiliate terminal and storing the affiliate payment information by each item when a payment event occurs; a user-side payment acquisition part receiving user payment information from a user terminal to store the user payment information by each item; a payment content matching part for matching contents of the affiliate payment information and the user payment information by each item to determine whether or not the affiliate payment information and the user payment information occur from the same payment event; and a point saving part for saving points in a user account corresponding to the user payment information.

### BRIEF DESCRIPTION OF THE DRAWINGS

These and/or other aspects will become apparent and more readily appreciated from the following description of the embodiments, taken in conjunction with the accompanying drawings in which:

FIG. 1 is a view illustrating a point saving system according to an embodiment of the present invention;

FIG. 2 is a view illustrating an internal configuration of an application server according to an embodiment of the present invention;

FIG. 3 is a view illustrating an exemplary matching of an application server between affiliate payment information and user payment information that are received according to an embodiment of the present invention;

FIG. 4 is a view illustrating communication between components according to an embodiment of the present invention; and

FIG. 5 is a flowchart illustrating a point saving process according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description

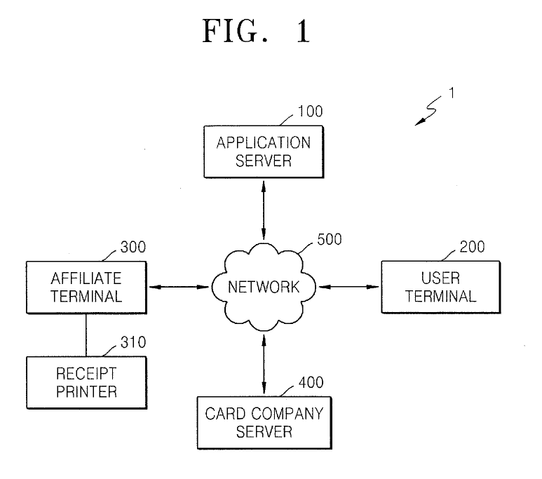

FIG. 1 is a view illustrating a point saving system 1 according to an embodiment of the present invention.

The point saving system 1 may include an application server 100, a user terminal 200, an affiliate terminal 300, a card company server 400, and a network 500.

The application server 100 may receive affiliate payment information from an affiliate terminal 300 when a payment event occurs, and may receive user payment information from a user terminal 200, and then may store points to a user account according to the matching information between the affiliate payment information and the user payment information. In this case, the user payment information may be extracted from the contents of the payment confirmation text received from the card company server 400.

The point saving system 1 may store points in a user account by matching the affiliate payment information acquired from the affiliate terminal 300 and the user payment information acquired from the user terminal 200, even though a user does not carry a point card or does not know user information corresponding to a credit card.

Particularly, the point saving system 1 may directly acquire the user payment information from the user terminal, and the user payment information may not be exposed to the other people without the agreement of a user. Also, since the saving method does not require a point saving card recognition unit in the affiliate terminal 300, an additional cost may not be needed. Also, a user may save points and may be informed whether or not points are saved without a point card only by installing an application in the user terminal 200 according to the point saving system 1. Also, it is possible for a user to automatically save points only by installing an application without a linkage with a card company.

More specifically, the application server 100 of the point saving system 1 may match the contents for each item of the affiliate payment information and the user payment information to save points in a user account corresponding to the user payment information that is matched. In this case, the affiliate payment information may be information acquired by the affiliate terminal 300 when a payment event occurs, and the user payment information may be information which an application installed in the user terminal 200 extracts from the payment confirmation text.

The internal configuration and the detailed functions of the application server 100 will be described later.

Also, in the following description, the payment event may occur when a user pays the amount asked in an affiliated store with a credit card (plastic card). In this embodiment, the credit card may include a debit card, a prepaid card, and a check card.

The user terminal 200 may be a terminal carried by a user who generates a payment event, and may be a smart phone in which an application can be installed. However, the present invention is not limited thereto, and the user terminal 200 may refer to any kind of devices which a user carries in a mobile environment. In one embodiment, the user terminal 200 may be a terminal in which an application implementing a partial function of the point saving system 1 is installed. A user may download the application from the application store to install the application in the user terminal 200.

The application installed in the user terminal 200 may have a function of accessing a text message that the user terminal 200 receives. Of course, the function may be executed only when a user agrees to access the text message during the installation of the application. The application may accesses all text messages that are received in the user terminal 200 to verify whether or not the received text messages are a payment confirmation text from a card company. When the text message is a payment confirmation text, the application may transmit the contents of the text message to the application server 100.

In this case, the user account information and the contents of the payment confirmation text that the application transmits may be called user payment information. That is, the user payment information may include a card company, a payment amount, an affiliated store name, and a payment time that are written in the payment confirmation text, and the user account information.

The affiliate terminal 300 may transmit the affiliate payment information to the application server 100 when a payment event occurs. The affiliate terminal 300 may be a credit card payment terminal or a Point of Sale (POS) terminal. The affiliate terminal 300 may include a module for transmitting the payment information to the application server 100.

The affiliate terminal 300 may transmit a payment approval request to the card company server 400, and may receive an approval completion signal from the card company server 400 and then transmit the affiliate payment information to the application server 100. Also, when the affiliate terminal 300 receives a payment approval signal, the affiliate terminal 300 may output a receipt for the corresponding payment event.

The affiliate payment information may include items such as a card company, a payment amount, an affiliated store name, and a payment time. The affiliate terminal 300 may monitor the payment event using a module installed in the affiliate terminal 300 to extract the affiliate payment information. Alternatively, the affiliate terminal 300 may acquire the affiliate payment information by a module installed at an output terminal when transmitting a signal to a receipt printer to output a receipt including the payment information.

More specifically, the affiliate terminal 300 may be connected to the receipt printer 310 that outputs the payment information. The receipt may include information about the payment contents, and a user may confirm the payment contents with the receipt and then may sign the payment approval. In one embodiment, data transmitted to the receipt printer 310 may be extracted to acquire the affiliate payment information, and then may be transmitted to the application server 100. When a module for saving and transmitting the affiliate payment information cannot be installed according to the characteristics of the affiliate terminal 300, a monitoring program may be installed in the output terminal directing to the receipt printer 310 to scan outputted contents and then recognize the texts for the acquisition of the payment information.

The card company server 400 may be a server of a card company of a credit card used in the payment event. The card company server 400 may receive the payment approval request from the affiliate terminal 300, and may determine whether or not there is a defect in the corresponding payment approval request. When the payment approval request is normal, the card company server 400 may transmit the approval completion signal to the affiliate terminal 300.

Also, when the approval of the corresponding payment event is completed, the card company server 400 may transmit a payment confirmation text to the user terminal 200. A payment confirmation text transmission service may be a service that allows a user to confirm the payment breakdown by transmitting a text including a brief payment content to a user. Through the payment confirmation text, users may confirm whether or not the corresponding payment event is correctly performed.

The network 500, which is a network that connects the user terminal 200, the affiliate terminal 300, the card company server 400, and the application server 100, may be a Value Added Network (VAN), a mobile network such as CDMA/WCDMA/LET, a WiFi network and line, and a combination thereof, but the network 500 is not limited thereto. Accordingly, the network 500 may include all networks that can transmit/receive data between components.

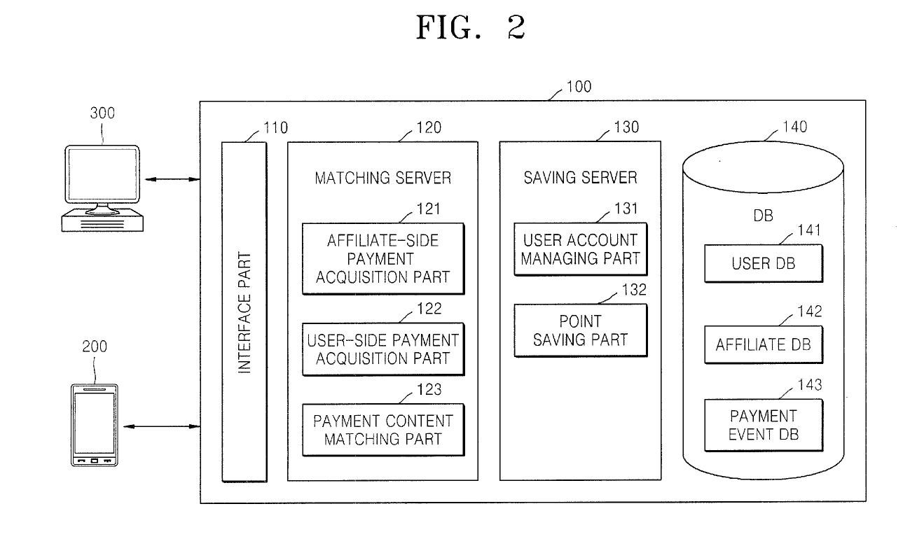

FIG. 2 is a view illustrating an internal configuration of an application server 100 according to an embodiment of the present invention. The application server 100 may communicate with the user terminal 200 or the affiliate terminal 300.

The application server 100 may include an interface part 110, a matching server 120, a saving server 130, and a database 140. The matching server 120 may include an affiliate-side payment acquisition part 121, a user-side payment acquisition part 122, and a payment content matching part 123. The saving server 130 may include a user account managing part 131 and a point saving part 132.

In FIG. 2, although the matching server 120 and the saving server 130 are shown as present in a single application server, the present invention is not limited thereto. The matching server 120 and the saving server 130 may be present in different application servers 100, or may serve as an independent server, respectively.

The interface part 110 may operate in linkage with the network 500 to provide a communication interface necessary to provide transmission/reception signals between the application server 100 and the user terminal 200/the affiliate terminal 300 in a form of packet data.

The matching server 120 may receive the payment information from the user terminal 200 or the affiliate terminal 300 to match each item, serving to determine whether or not the affiliate payment information and the user payment information occur from the same payment event.

The affiliate-side payment acquisition part 121 may serve to receive and store the affiliate payment information by each item when a payment event occurs from the affiliate terminal 300. When a user requests a card payment in an affiliated store using a credit card, the owner of the affiliated store may perform the payment of the amount by allowing the affiliate terminal 300 to recognize the credit card. When the payment amount is inputted by allowing the affiliate terminal 300 to recognize the credit card, the payment event may be performed. When the affiliate terminal 300 receives a payment approval signal from the card company server 400, the affiliate terminal 300 may transmit the affiliate payment information to the application server 100.

The items of the affiliate payment information that the affiliate-side payment acquisition part 121 receives and stores may include an affiliated store name, a payment time, a credit card number, and an approval number. In addition, the affiliate-side payment acquisition part 121 may acquire other items of the affiliate payment information that can be extracted.

Also, the affiliate-side payment acquisition part 121 may extract the affiliate payment information from data outputted on the payment receipt. As described above, when a module that monitors the payment information and transmits the payment information to the application server 100 is not installed in the affiliate terminal 300, the affiliate-side payment acquisition part 121 may acquire the affiliate payment information extracted from the output data transmitted from the affiliate terminal 300 to the receipt printer 310.

The affiliate-side payment acquisition part 121 may extract items necessary for the payment information confirmation, and may store the items in a payment event database 143. More specifically, the affiliate-side payment acquisition part 121 may extract items such as a card company, a payment amount, an affiliate store name, and a payment time from the affiliate payment information, and may store the items in the payment event database 143.

Next, the user-side payment acquisition part 122 may serve to receive the user payment information from the user terminal 200, and may store the user payment information by each item. The user payment information may include information extracted from the payment confirmation text received in the user terminal 200 and the user account information.

As described above, the payment confirmation text, which is a message that informs the user terminal 200 that the payment event is approved, may be transmitted from the card company server 400 to the user terminal 200. A saving application installed in the user terminal 200 monitors texts that are received. When a text having a form of payment confirmation is received from the card company, the saving application may recognize the text as a payment confirmation text, and then may transmit the contents thereof to the user-side payment acquisition part 122.

Also, the saving application may transmit the payment confirmation text together with the user account information that enables the recognition of the user terminal 200. For example, the user account information may be a mobile number of the user terminal 200. Accordingly, the user-side payment acquisition part 122 may receive the user payment information including information extracted from the received payment confirmation text and the user payment information including the user account information.

The user-side payment acquisition part 122 may extract contents for each item from the received user payment information, and then may store the contents in the payment event database 143. For example, the user-side payment acquisition part 122 may extract contents about [the card company, the payment amount, the payment time, and the user account information] from the user payment information, and may store the contents.

The payment content matching part 123 may match the affiliate payment information and the user payment information by each item to determine whether or not the affiliate payment information and the user payment information occur from the same payment event.

More specifically, the payment content matching part 123 may determine the matching or not by each item by calculating the similarity by each item even though the contents by each item do not completely match each other. For example, [affiliated store name] shown in the affiliate payment information and [affiliated store name] shown in the user payment information may be partially different from each other. Since the affiliate payment information is information outputted in the receipt, the whole of the affiliated store name may be written. However, in case of the payment confirmation text, only a portion of the affiliated store name may be written due to a limitation of the text length of the payment confirmation text.

When the payment content matching part 123 determines that the affiliate payment information and the user payment information occurs from the same payment event, the payment content matching part 123 may store information about the similarity and the matching or not in the event database 143, and may transmit the contents of the matched items to the saving server 130.

The user account managing part 131 of the saving server 130 may create a user account when a user subscribes to the saving service of the present invention through the application of the user terminal 200, and may store the user account in the user database 141. In this case, when the user account managing part 131 creates the user account, the user account managing part 131 may also register a unique number assigned to the user terminal 200, e.g., the mobile number of the user terminal 200. The user account managing part 131 may register the point saving situation of registered user accounts and other information related to the user accounts in the user database 141.

When the payment content matching part 123 determines that the affiliate payment information and the user payment information occur from the same payment event, the point saving part 132 may save points in the user account corresponding to the matched user payment information.

As described above, the user payment information may include the affiliated store name, the payment amount, and the user account information. The point saving part 132 may save points in the user account using the user payment information. In one embodiment, the point saving part 132 may differently determine the point saving amount for each user and affiliate.

The data base 140, which is a database arranging and storing data used by the application server 100, may include a user database 141, an affiliate database 142, and a payment event database 143.

The user database 141, the affiliate database 142, and the payment event database 143 have been described as different databases for convenience of explanation, but data stored in each database may be connected to each other.

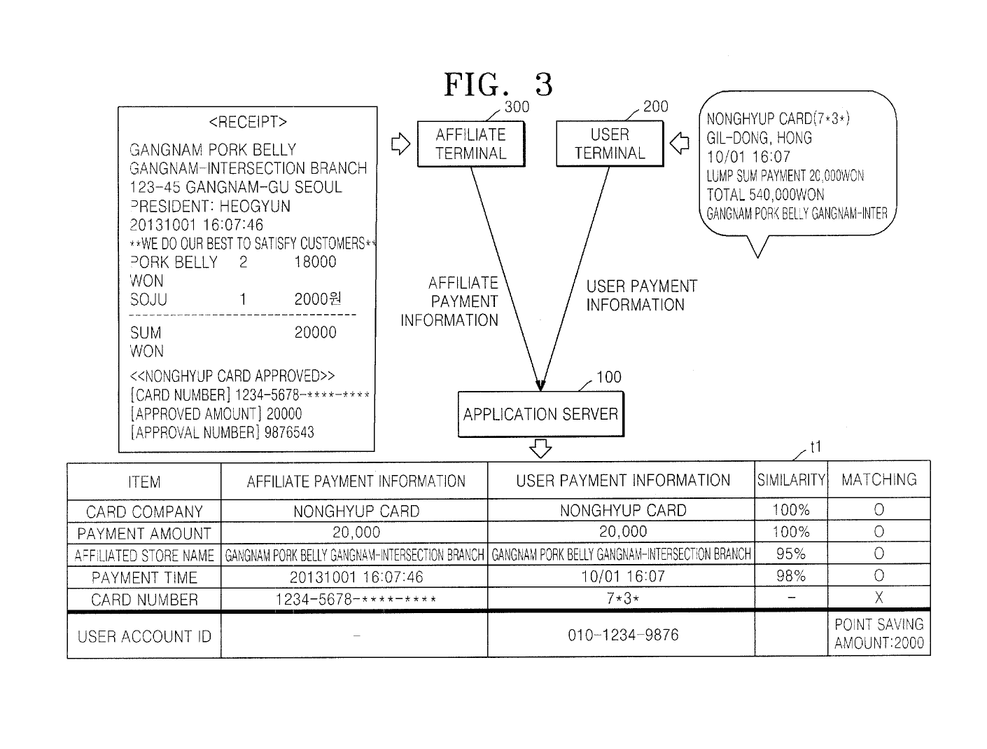

FIG. 3 is a view illustrating an exemplary matching of an application server between affiliate payment information and user payment information that are received according to an embodiment of the present invention.

First, when a payment event occurs, the affiliate-side payment acquisition part 121 of the application server 100 may receive the affiliate payment information from the affiliate terminal 300 to store the affiliate payment information in the payment event database 143 by each item. In this case, a payment event table as shown at the lower side of FIG. 3 may be created in the payment event database 143 of the application server.

More specifically, the affiliate-side payment acquisition part 121 may store the affiliate payment information by each item in the column of the affiliate payment information of the payment event table like Table 1 (t1). In the embodiment of FIG. 3, it will be exemplified that the affiliate terminal 300 scans a receipt issued by a payment event to create the affiliate payment information.

In the embodiment of FIG. 3, the affiliate payment information may be information obtained by extracting receipt output contents delivered from the affiliate terminal 300 to the receipt printer 310. The affiliate terminal 300 may transmit the contents written in <receipt> to the application server 100 as the affiliate payment information.

<Receipt> may include information about the card company, the payment amount, the affiliated store name, and the payment time. More specifically, in the embodiment of FIG. 3, the card company is ‘Nonghyup Card’, and the payment amount is ‘20,000’. Also, the affiliated store name is ‘Gangnam Pork Belly Gangnam-intersection Branch’, and the payment time is ‘20131001 16:07:46’. The affiliate payment information including the foregoing contents may be transmitted to the application server 100.

The affiliate-side payment acquisition part 121 of the application server 100 may receive the affiliate payment information to store the affiliate payment information in the payment event database 143 by each item. The payment event database may be provided with tables like Table 1 (t1) whenever payment events occur.

The affiliate-side payment acquisition part 121 may complete the contents of the column of the affiliate payment information of Table 1 (t1). Each content corresponding to the item column may be stored in the column of the affiliate payment information. In the embodiment of FIG. 3, [Nonghyup Card, 20000, Gangnam Pork Belly Gangnam-intersection Branch, 20131001 16:07:46] may be stored in [card company, payment amount, affiliated store name, payment time], respectively. Also, the affiliate-side payment acquisition part 121 may store information extracted from the affiliate payment information in additional items such as card number in addition to the essential items.

In addition to the example shown in FIG. 3, the item, order, and form of the payment information acquired by the affiliate-side payment acquisition part 121 may vary according to the types of the affiliate terminal 300. Accordingly, the affiliate-side payment acquisition part 121 may store only acquired information, and may allow items in which payment information is absent to be vacant.

Alternately, the affiliate-side payment acquisition part 121 may store only the essential items for confirming the payment information, i.e., items of [card company, payment amount, affiliated store name, payment time] in the payment event table, and may delete other items of the affiliate payment information.

Next, the user terminal 200 may transmit the user payment information including the received text and the account information of the user terminal 200 to the application server 100. The user-side payment acquisition part 122 of the application server 100 may receive the user payment information to store the user payment information in the payment event database 143 by each item.

In FIG. 3, the user-side payment acquisition part 122 may store each item of the user payment information in the column of the user payment information of Table 1 (t1) of the payment event database 143. The user payment information may include the contents of the payment confirmation text that the user terminal 200 receives from the card company server 400. The payment confirmation text may include the item contents of the card company, the payment amount, the affiliated store name, and the payment time. In FIG. 3, the card company is Nonghyup card, and the payment amount is 20,000. Also, the affiliated store name is Gangnam Pork Belly Gangnam-intersection Branch, and the payment time is 10/01 16:07.

Also, the account information (user account ID) of the user terminal 200 may be a mobile number of the user terminal 200. The account information of the user terminal 200 included in the user payment information may be used to determine which the user account corresponds to. The user account information may be connected to the user account data stored in the user database 141.

The user-side payment acquisition part 122 may store the acquired user payment information in the payment event table of the payment event database 143. In the embodiment of FIG. 3, the user-side payment acquisition part 122 may store each item of the user payment information in the column of the user payment information of Table 1 (t1). More specifically, in the embodiment of FIG. 3, [Nonghyup Card, 20,000, Gangnam Pork Belly Gangnam-intersection Branch, 10/01 16:07] may be stored in [card company, payment amount, affiliated store name, payment time] of the column of the user payment information, respectively. Also, the user-side payment acquisition part 122 may store a mobile number [010-1234-9875] of the user terminal 200 in [user account ID], and may also store information extracted from the affiliate payment information in additional items such as card number in addition to the essential items.

The payment content matching part 123 of the application server 100 may match contents for each items of the affiliate payment information and the user payment information to determine whether or not the similarity by each item is equal to or larger than a reference value. In the embodiment of FIG. 3, the payment content matching part 123 may complete the column of the similarity and the column of the matching of Table 1 (t1). In this case, the payment content matching part 123 may determine that the items match each other when the similarity is equal to or greater than a reference value even though the contents of the affiliate payment information and the user payment information by each item do not coincide with each other.

For example, regarding the item [affiliated store name], the affiliate payment information may be described as [Gangnam Pork Belly Gangnam-intersection Branch], and the user payment information may be described as [Gangnam Pork Belly Gangnam-inter]. In this case, the contents of the two columns may not accurately coincide with each other. This is because since the user payment information is extracted from the text message, a tail portion of data can be omitted due to a length limitation of the text message. Even in this case, the payment content matching part 123 may determine that the corresponding items are matched when the similarity is equal to or greater than the reference value. Finally, the payment content matching part 123 may match the affiliate payment information and the contents of the payment confirmation text by each item when the similarity is equal to or greater than the reference value even though the contents by each item do not coincide with each other.

When the similarity is equal to or greater than the reference value, the payment content matching part 123 may mark matching or not in the column of matching. When the number of matched items is equal to or greater than a certain number, it is determined that the corresponding affiliate payment information and user payment information occur from the same payment event. Particularly, the payment content matching part 123 may determine that the corresponding affiliate payment information and user payment information occur from the same payment event when the essential items, i.e., card company, payment amount, affiliated store name, and payment time are matched.

When the payment content matching part 123 determines that the affiliate payment information and the user payment information occur from the same payment event, the point saving part 132 may save points in the user account corresponding to the account information including the user payment information. As described above, when the application is installed in the user terminal 200, a user may subscribe to the point saving system according to an embodiment of the present invention, and may register information on his/her own user account and user terminal 200 in the user database 141. The point saving part 132 may save points generated from a corresponding payment event in the user account of the user database 141. In the embodiment of FIG. 3, the point saving amount of [2,000] may be saved in the corresponding user account.

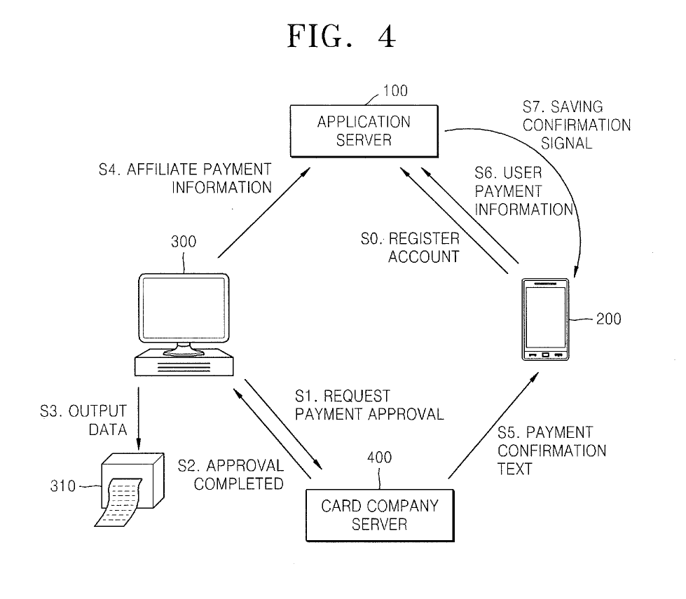

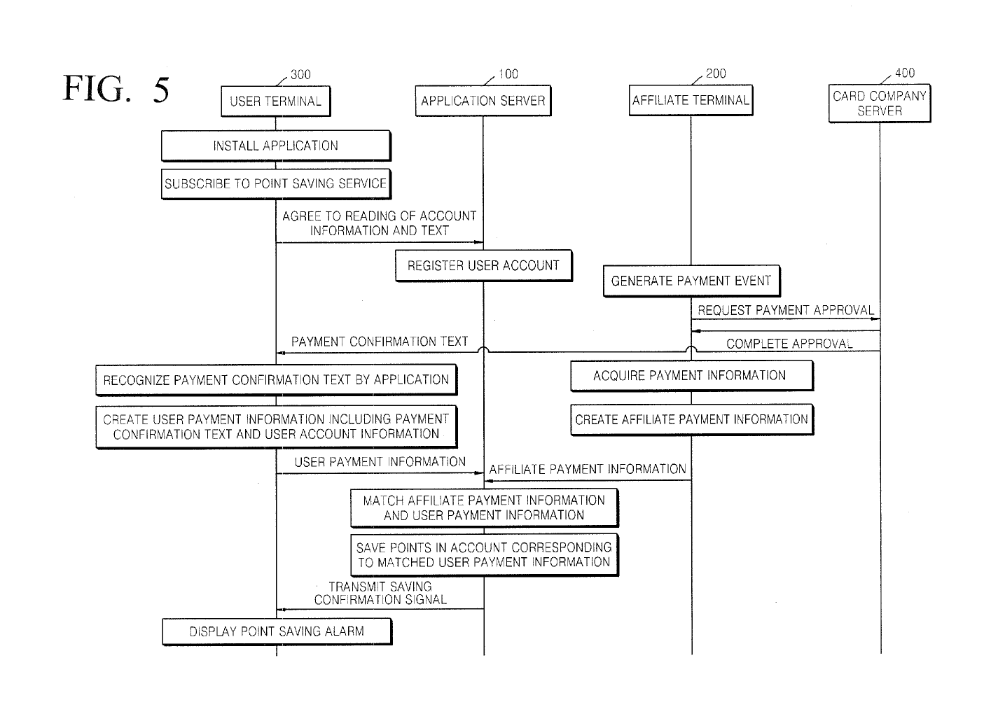

FIG. 4 is a view illustrating a communication between components according to an embodiment of the present invention. FIG. 5 is a flowchart illustrating a point saving process according to an embodiment of the present invention.

First, a user may subscribe to the point saving system according to the embodiment of the present invention by registering his/her account in the application server 100 using the user terminal 200 (S0) In this case, a user may install the application of the point saving system in the user terminal 200, and may agree to reading of the account information and text message.

When a payment event occurs, the affiliate terminal 300 may transmit a payment approval request S1 to the card company server 400, and the card company server 400 may transmit an approval completion signal to the affiliate terminal 300 (S2). Also, the card company server 400 may transmit a payment confirmation text to the user terminal 300.

The affiliate terminal 300 receiving the approval completion signal may transmit output data to the receipt printer 310 (S3), and may transmit a result of monitoring the output data to the application server 100 as the affiliate payment information (S4). The user terminal 200 may receive the payment confirmation text from the card company server 400 (S5) to create the user payment information, and then may transmit the user payment information to the application server 100 (S6).

The application server 100 may match the received affiliate payment information and user payment information to determine whether or not the affiliate payment information and the user payment information occur from the same payment event and then save points in the user account. When points are saved in the user account, a saving confirmation signal may be transmitted to a corresponding user terminal 200 (S7). The user terminal 300 may display a point saving alarm.

As described above, according to the one or more of the above embodiments of the present invention, it is unnecessary for a user to carry a point saving means.

According to the one or more of the above embodiments of the present invention, points can be automatically saved without an additional action of a user for the point saving.

According to the one or more of the above embodiments of the present invention, information on a point saving situation may be provided to a user terminal whenever a payment event occurs.

According to the one or more of the above embodiments of the present invention, since payment approval information is provided only when a user agrees, damage by personal information exposure can be prevented.

According to the one or more of the above embodiments of the present invention, the possibility of wrong point saving can be reduced.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A mobile point saving system comprising:
an affiliate-side payment acquisition part receiving affiliate payment information from an affiliate terminal and storing the affiliate payment information by each item when a payment event occurs;
a user-side payment acquisition part receiving user payment information from a user terminal to store the user payment information by each item;
a payment content matching part for matching contents of the affiliate payment information and the user payment information by each item to determine whether or not the affiliate payment information and the user payment information occur from the same payment event; and
a point saving part for saving points in a user account corresponding to the user payment information.

2. The mobile point saving system of claim 1, wherein the user payment information comprises information extracted from a text message received by the user terminal

3. The mobile point saving system of claim 1, wherein the payment content matching part determines whether or not the affiliate payment information and the user payment information occur from the same payment event by determining whether or not an item similarity of the affiliate payment information and the user payment information is equal to or greater than a reference value.

4. The mobile point saving system of claim 1, wherein the affiliate payment information comprises a card company, a payment amount, an affiliated store name, and a payment time.

5. The mobile point saving system of claim 1, wherein the user payment information comprises a card company, a payment amount, an affiliated store name, a payment time, and a user account.

6. The mobile point saving system of claim 1, wherein the user payment information is information extracted a payment confirm text that an application installed in the user terminal receives from a card company by accessing a text message.

7. The mobile point saving system of claim 1, wherein the affiliate payment information is information acquired by extracting output contents when the affiliate terminal transmits the output contents to a receipt printer.

8. The mobile point saving system of claim 1, wherein the point saving part transmits a point saving confirmation signal to the user terminal after saving points in the user account.

9. The mobile point saving system of claim 1, further comprising a user account managing part that receives user account information from the user terminal to register the user account information.

10. The mobile point saving system of claim 1, wherein:
the affiliate-side payment acquisition part, the user-side payment acquisition part, and the payment content matching part are comprised in a matching server;
the point saving part is comprised in a saving server; and
the matching server and the saving server independently exist.

11. A mobile point saving method comprising:
receiving affiliate payment information from an affiliate terminal to store affiliate payment information by each item;
receiving user payment information from a user terminal to store user payment information by each item;
determining whether or not the affiliate payment information and the user payment information occur from the same payment event; and
saving points in a user account corresponding to the user payment information

12. The mobile point saving method of claim 11, wherein the determining of whether or not the affiliate payment information and the user payment information occur from the same payment event comprises:
matching the affiliate payment information and the user payment information by each item;
determining whether a similarity by each item is equal to or greater than a reference value; and
determining whether or not the affiliate payment information and the user payment information occur from the same payment event based on the matching by each item.

13. The mobile point saving method of claim 11, wherein the user payment information comprises information extracted from a text message received by the user terminal.

14. The mobile point saving method of claim 11, wherein the affiliate payment information comprises a card company, a payment amount, an affiliated store name, and a payment time, and the user payment information comprises a card company, a payment amount, an affiliated store name, a payment time, and a user account.

15. The mobile point saving method of claim 11, further comprising receiving user account information from the user terminal.

16. The mobile point saving method of claim 11, further comprising saving points in the user account and then transmitting a point saving confirmation signal to the user terminal.
